(19) United States
(12) Patent Application Publication
(10) Pub. No.: US 2026/0070208 A1
(43) Pub. Date: Mar. 12, 2026

(54) Knife with Grip Features and Multi-Use Striker

(71) Applicant: Grant Philip Colley, North Scituate, RI (US)

(72) Inventor: Grant Philip Colley, North Scituate, RI (US)

(21) Appl. No.: 18/827,699

(22) Filed: Sep. 7, 2024

(51) Int. Cl. B25G 1/10; A62B 3/00; B26B 9/00; B26B 11/00

(52) U.S. Cl. CPC B25G 1/102; B26B 9/00; B26B 11/00; A62B 3/00

(57) ABSTRACT

A knife with gripping features for a variety of different uses. Gripping surfaces are positioned on opposing sides of the blade above the cutting edge, along the top of the handle and along the bottom of the handle. A multi-use striker feature is included at the butt end of the handle. Grip improvements make a knife both easier and safer to use.

### BACKGROUND

Knives are used for a variety of everyday purposes including slicing, piercing, chopping, prying, digging and for precise delicate work with the point. Delicate point work can range from cutting individual threads in cloth to repositioning zipper teeth. Specific grip features are needed depending on the type of work to be done.

Water, oil, paint, sweat and other viscous liquids on the user's hands make it difficult to get a good secure grip on the knife handle. A bad grip can lose control of the knife causing injury or damage.

The further the grip is away from the cutting edge, the more strength is needed to put pressure on the cutting edge.

Intricate work with the blade point requires precise and fine movement of the point. This type of fine delicate work is difficult to do by using the knife handle. The handle is too far away from the blade point to have precise control of the point.

Traditional strikers at the butt end of the handle are pointed triangles or cones. A pointed striker requires that the surface, such as glass, be struck precisely on the apex. The user's hand and arm must be exactly positioned for an effective strike on the point. Any strike that does not land exactly on the point may be deflected off the surface. If that happens, follow-up strikes would be required until an accurate strike is achieved resulting in extra time and effort.

### BRIEF SUMMARY

Three (3) gripping features are added to the knife. The blade runs full length from the blade tip to the butt end of the handle.
1. Serrations run along the top of the blade in the handle to increase grip friction (FIGS. 1, 104).
2. The blade is recessed into the bottom of the handle. The recess provides resistance for the grip against a knife twisting (FIGS. 6, 508)
3. On the blade above the cutting edge, grooves run along opposing sides of the blade. The grooves are a gripping surface for fine point work (FIGS. 9, 102). The grooves on opposing sides of the blade are also a gripping surface for holding the blade from the top to apply cutting pressure on the cutting edge (FIGS. 10, 102).

A striker at the butt end of the handle has a radius for more effective striking angles (FIGS. 1, 106). A vertex runs the full radius of the striker (FIGS. 7, 106), (FIGS. 2, 106), (FIGS. 4, 106). The entire radius of the vertex is the striking point.

### DESCRIPTION OF DRAWINGS

FIG. 1 is an isometric view of the knife. FIG. 1 shows the grooves on opposing sides of the blade above the cutting edge (102), the serrations on the top of the handle (104) and the radius striker (106).

FIG. 2 illustrates the right side of the knife. FIG. 2 shows the grooves on the right side of the blade (102) above the cutting edge. Included are serrations (104) on the top of the handle and radiused striker (106).

FIG. 3 illustrates the left side of the knife. It shows the grooves (102) on the left side of the blade above the cutting edge. Included are serrations (104) on the top of the handle and radiused striker (106).

FIG. 4 is an isometric view of the top of the knife. It shows the serrations (104) on the top of the handle. Included are grooves (102) on opposing sides of the blade above the cutting edge and the radiused striker (106).

FIG. 5 is an isometric view of the bottom of the knife. It shows the blade recessed (508) along the bottom of the handle. Included are the radiused striker (106) at the butt end of the handle and the grooves (102) on opposing sides of the blade above the cutting edge.

FIG. 6 is a cross section view of the handle. It shows the blade recessed (105) in the bottom of the handle. Included are the raised serrations (104) along the top of the handle.

FIG. 7 Illustrates the butt end of the handle. It shows the striker (106) with vertex and the raised serrations (104) on the top of the handle.

FIG. 8 Illustrates the top side of the knife. It shows the vertex of the striker radius (106). It also shows the serrations (102) along the entire length of the handle.

FIG. 9 illustrates the grip on the grooves (102) on opposing sides of the blade above the cutting edge as used for intricate point work. It shows the point as it could be used on the work surface.

FIG. 10 Illustrates the grip on the grooves (102) on opposing sides of the blade for applying direct force on the cutting edge.

### DETAILED DESCRIPTION

The blade runs full length from the tip of the blade to the butt end of the handle. References to blade features will relate to the point, cutting edge, handle and butt end of the handle.

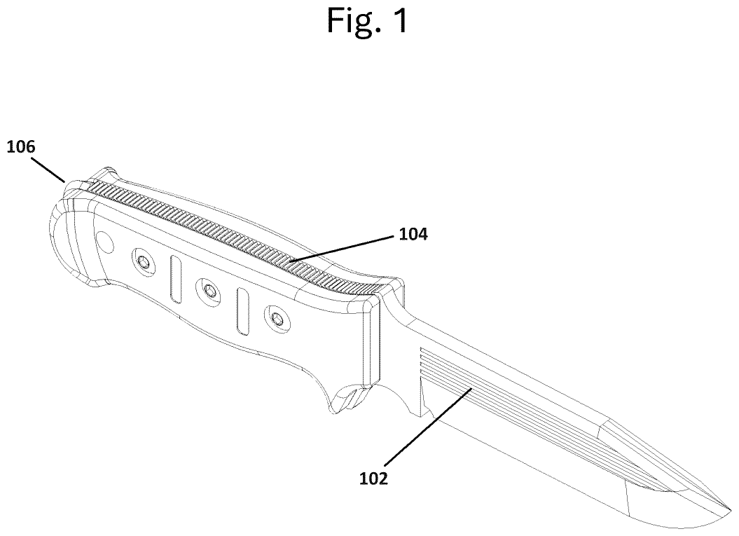

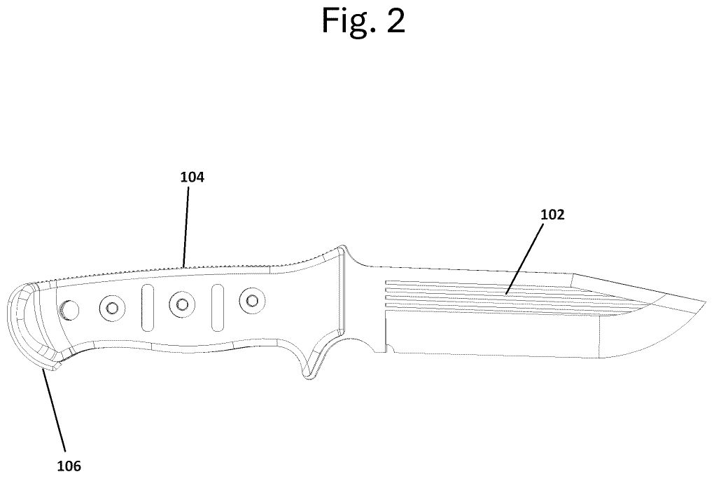

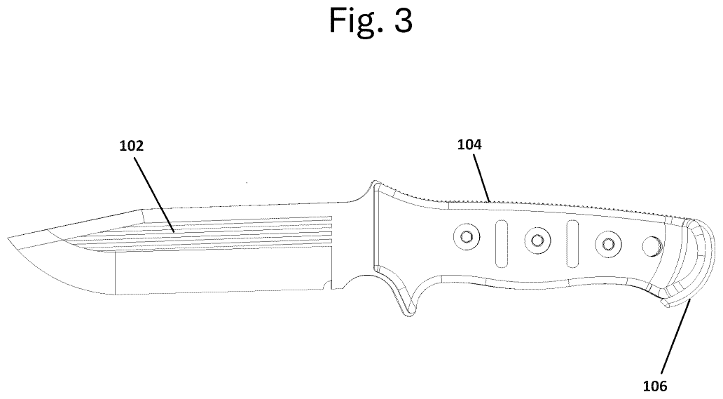

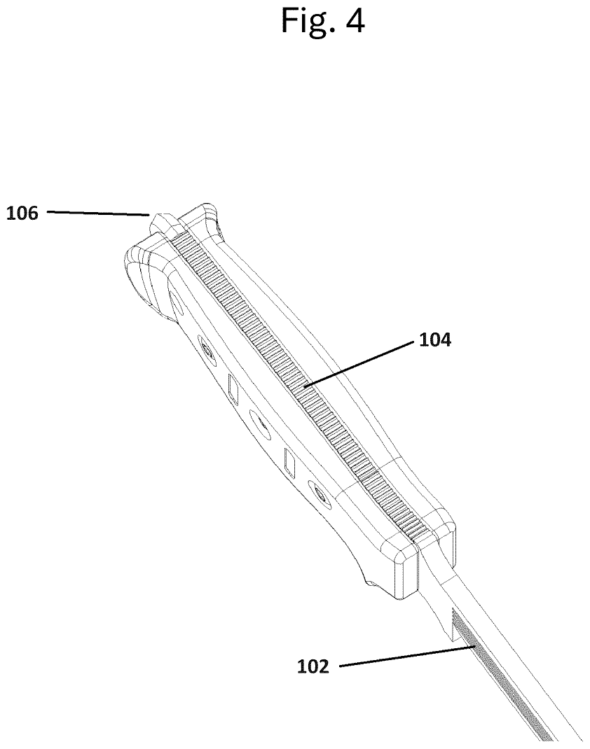

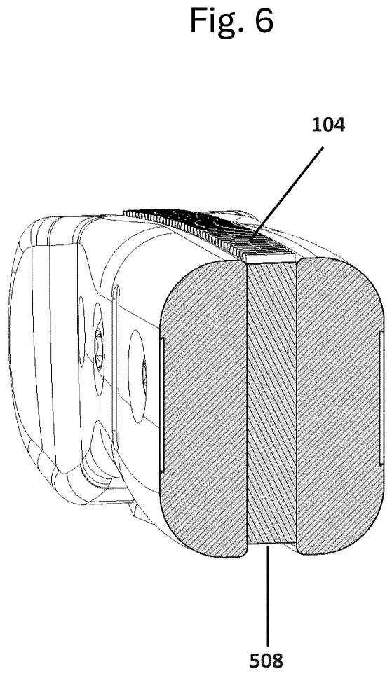

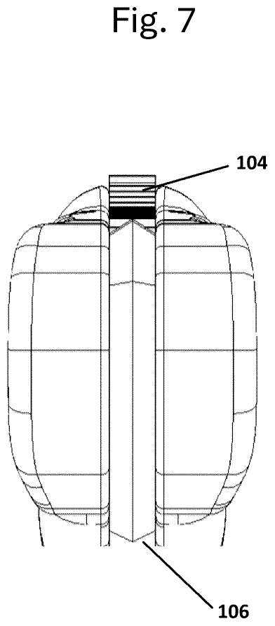

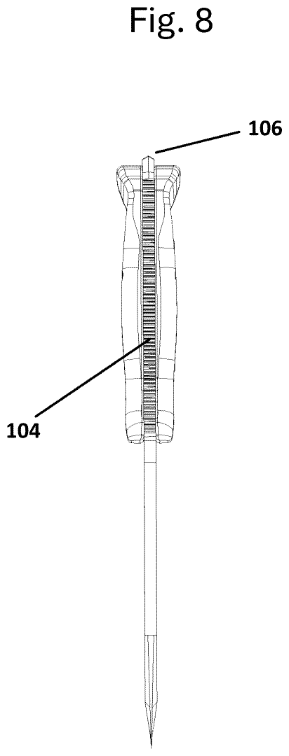

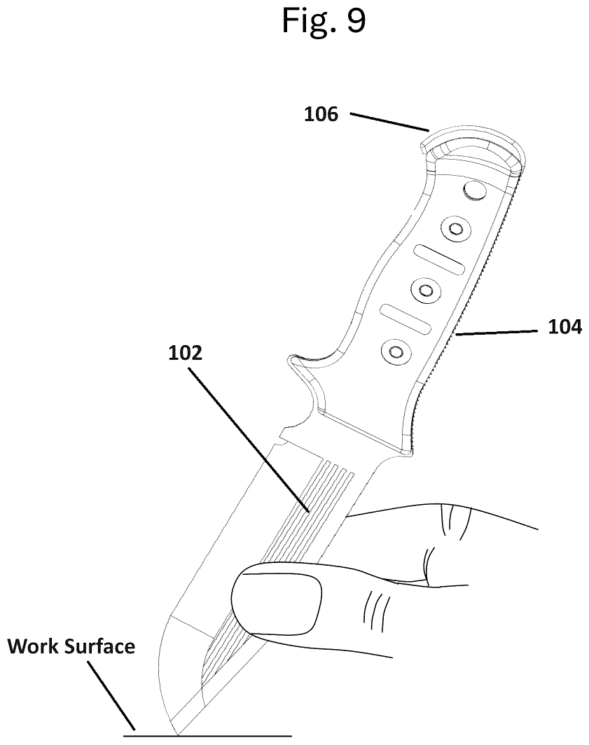

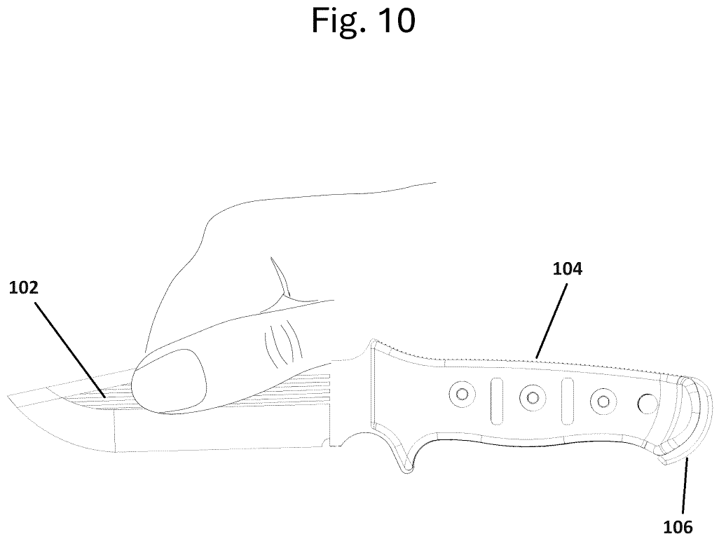

The first aspect is a series of serrations (104) on the top of the blade in the handle. The serrations rise above the top of the handle. Being higher than the top of the handle, the serration points impress slightly into the hand. Serrations on top of the handle are shown as 104 (FIG. 1, FIG. 2, FIG. 3, FIG. 4, FIG. 6, FIG. 7, FIG. 8, FIG. 9, FIG. 10). FIG. 6 is a cross section of the knife handle showing serrations (104) on the top of the handle.

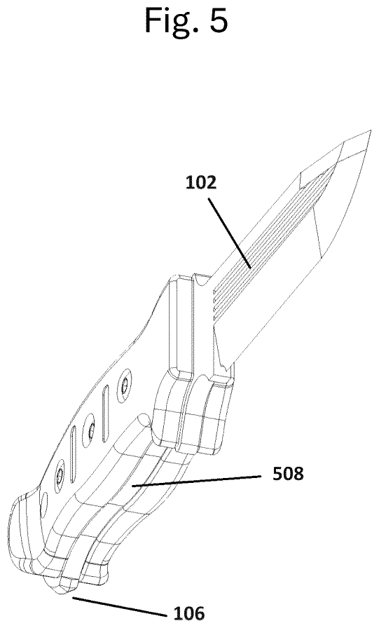

The second aspect is that the blade in the bottom of the handle is recessed (FIGS. 5, 508 and FIGS. 6, 508) in between the sides of the handle. When gripped, the hand is pressed into the recess. The sides of the handle against the hand, in the recess, provide resistance against knife twisting. FIG. 6 is a cross section of the knife handle showing the recess (508) in the bottom of the handle.

The third aspect are grooves on opposing sides of the blade above the cutting edge (FIGS. 2, 102 and FIGS. 3, 102). The grooves (102) are a gripping surface for intricate point work (FIG. 9) as well as for applying pressure directly to the blade edge (FIG. 10).

A fourth aspect is a striker (106) located at the butt end of the handle. The striker has a radius from the top of the handle to the bottom of the handle. The striking surface is a sharp vertex that runs full length of the radius (FIG. 2, FIG. 7, FIG. 8).

Serrations (104) on the top of the handle rise above the top of the handle for a secure grip (FIG. 1, FIG. 6, FIG. 7). The points of the serrations press into the hand providing resistance to the hand sliding forward, backward, left and right.

The serrations (104) on top of the handle also displace liquids on the hand improving the grip when a hand is wet with water, oil, sweat, or other liquids (FIG. 1, FIG. 6, FIG. 7).

When holding the knife, the hand is gripped into the recess (508 FIG. 5, FIG. 6) at the bottom of the handle. The recess provides support for the hand against twisting forces on the handle. Twisting of the knife can potentially injure the user as well as damage the work.

Grooves (102) are on opposing sides of the blade above the cutting edge (FIG. 2 and FIG. 3). These grooves are gripping surfaces for intricate point work (FIG. 9). The knife blade is gripped from the top for angling the blade point down onto the work surface. The knife blade is held much like a pen or pencil. Positioning the blade in this way provides both fine and precise control of the point for detailed work.

Grooves are on opposing sides of the blade above the cutting edge (FIGS. 2, 102 and FIGS. 3, 102). These grooves are gripping surfaces for applying pressure directly on the blade edge. The knife blade is gripped from the top for pressing down on the blade edge onto the work surface (FIG. 10).

A striker is located at the butt end of the handle (106 FIG. 1, FIG. 2, FIG. 3, FIG. 4, FIG. 5, FIG. 7, FIG. 8, FIG. 9, FIG. 10). The striker has a radius (106 FIG. 2, FIG. 3, FIG. 7) from the top of the handle to the bottom of the handle. It has a vertex (106) that serves as the striking point and runs full length of the radius. Traditional strikers at the butt end of the handle are pointed triangles or cones. A pointed striker requires that the surface, such as glass, be struck precisely on the point. The user's hand and arm must be exactly positioned for an effective strike on the point. Any strike that does not land exactly on the point may be deflected off the surface. If that happens, follow-up strikes would be required until an accurate strike is achieved, resulting in extra time and effort. For example, a first responder would use the striker to break car windows to rescue crash victims. Personal use could be to break windows to exit a car or building. Everyday use examples include breaking or cracking glass, plastic, wood, ceramics and slate. FIGS. 4, 106 and FIGS. 7, 106 is a view of the radiused vertex striker.

1. A knife comprising serrations that run along full length on the top of the handle and rising above the handle to prevent the hand grip from slipping forward and backward, twisting left and right (104 FIG. 1, FIG. 2, FIG. 3, FIG. 4, FIG. 6, FIG. 7, FIG. 8, FIG. 9, FIG. 10).

2. Said knife comprising a recess in the bottom of the handle to resist twisting of the knife while gripped (508 FIG. 5 and FIG. 6).

3. Said knife comprising grooves on opposing sides of the blade above the cutting edge serve two purposes: one purpose provides a grip surface for fine precise point work (FIG. 9, 102), the other purpose provides a grip surface for applying direct pressure on the blade edge (FIG. 10, 102).

4. Said knife comprising a striker at the butt end of the handle that has a radius and a vertex that runs full length of the radius, offering many degree angles of strikes making the striker more effective (106 FIG. 1, FIG. 2, FIG. 3, FIG. 4, FIG. 5 , FIG. 7, FIG. 8, FIG. 9, FIG. 10).
